(19) United States
(12) Patent Application Publication
(10) Pub. No.: US 2024/0413498 A1
(43) Pub. Date: Dec. 12, 2024

(54) LEAD WIRE AND POWER STORAGE DEVICE

(71) Applicant: SUMITOMO ELECTRIC INDUSTRIES, LTD., Osaka (JP)

(72) Inventors: Yusuke KUREISHI, Osaka (JP); Kengo GOTO, Osaka (JP); Mitsuyasu OGAWA, Osaka (JP); Hanano SASAKI, Tochigi (JP); Kazuhiro GOTO, Osaka (JP)

(73) Assignee: SUMITOMO ELECTRIC INDUSTRIES, LTD., Osaka (JP)

(21) Appl. No.: 18/694,973

(22) PCT Filed: Oct. 7, 2021
(86) PCT No.: PCT/JP2021/037185

§ 371 Date: Mar. 24, 2024

(51) Int. Cl. H01M 50/562; H01B 1/02; H01M 50/191; H01M 50/193; H01M 50/197

(52) U.S. Cl. CPC H01M 50/562; H01B 1/023; H01B 1/026; H01M 50/191; H01M 50/193; H01M 50/197

(57) ABSTRACT

A lead wire including a lead conductor and a film covering at least a part of a surface of the lead conductor, wherein the film includes a trivalent chromium compound and a first metal, and a ratio of a concentration of the first metal to a concentration of the trivalent chromium compound on a surface of the film is 0.01 or more and 4.0 or less.

### TECHNICAL FIELD

The present disclosure relates to a lead wire and a power storage device.

### BACKGROUND ART

Typically, in a power storage device such as a lithium ion secondary battery, battery elements (a positive electrode, a negative electrode and an electrolytic solution) are housed in a container and a lead conductor for taking a current out to the outside extends from the inside to the outside of the container. The container and the lead conductor are joined by, for example, thermal fusion with a resin, to thereby seal the battery elements.

However, the joining force decreases gradually with the passage of time, which causes separation of the lead conductor from the container. This is because water transmits through the joined portion with the passage of time and reacts with the electrolytic solution housed in the container to form hydrofluoric acid, which corrodes the lead conductor. Therefore, the lead conductor requires corrosion resistance, adhesiveness and the like.

### CITATION LIST

### Patent Literature

PTL 1: Japanese Patent Laying-Open No. 2015-156365
PTL 2: Japanese Patent Laying-Open No. 2016-184494

### SUMMARY OF INVENTION

A lead wire according to an aspect of the present disclosure is a lead wire including a lead conductor and a film covering at least a part of a surface of the lead conductor, wherein
the film includes a trivalent chromium compound and a first metal, and
a ratio of a concentration of the first metal to a concentration of the trivalent chromium compound on a surface of the film is 0.01 or more and 4.0 or less.

A lead wire according to another aspect of the present disclosure is a lead wire including a lead conductor and a film covering at least a part of a surface of the lead conductor, wherein
the film includes a trivalent chromium compound and a hydroxide of an element constituting a first metal,
the trivalent chromium compound includes chromium hydroxide,
a ratio of a concentration of chromium hydroxide to a concentration of the trivalent chromium compound on a surface of the film is 0.3 or more and 0.9 or less, and
a ratio of a concentration of the hydroxide of the element constituting the first metal to the concentration of the trivalent chromium compound on the surface of the film is 0.01 or more and 1.0 or less.

A lead wire according to still another aspect of the present disclosure is a lead wire including a lead conductor and a film covering at least a part of a surface of the lead conductor, wherein
the film includes a trivalent chromium compound, a first metal and a calcium compound, and
a ratio of a concentration of calcium to a concentration of the trivalent chromium compound on a surface of the film is 0.01 or more and 1.0 or less.

A power storage device according to the present disclosure includes the lead wire according to the present disclosure.

### BRIEF DESCRIPTION OF DRAWINGS

FIG. 1 is a partial cross-sectional view of a lead wire according to each of first to third embodiments.

FIG. 2 is an overall cross-sectional view of the lead wire according to each of the first to third embodiments.

### DETAILED DESCRIPTION

### Problem to be Solved by the Present Disclosure

Improvement in corrosion resistance and adhesiveness of a lead conductor has been conventionally desired. In order to solve such a problem, Japanese Patent Laying-Open No. 2015-156365 (PTL 1), for example, discloses a lead wire including a film including trivalent chromium and covering a surface of a lead conductor, and a thermal fusion layer covering a surface of the film. In addition, Japanese Patent Laying-Open No. 2016-184494 (PTL 2) discloses a lead wire including a two-layered nickel-plated layer covering a surface of a lead conductor, and a film of trivalent chromium covering the nickel-plated layer. However, sufficient corrosion resistance and adhesiveness have not necessarily been attained.

The present inventors have considered that a higher degree of corrosion resistance and adhesiveness than those of conventional lead wires are desirable, and have completed the present disclosure.

Accordingly, an object of the present disclosure is to provide a lead wire having a high degree of corrosion resistance and adhesiveness.

### Advantageous Effect of the Present Disclosure

According to the present disclosure, it is possible to provide a lead wire having a high degree of corrosion resistance and adhesiveness.

### DESCRIPTION OF EMBODIMENTS

First, aspects of the present disclosure will be listed and described.

[1] A lead wire according to an aspect of the present disclosure is a lead wire including a lead conductor and a film covering at least a part of a surface of the lead conductor, wherein
the film includes a trivalent chromium compound and a first metal, and
a ratio of a concentration of the first metal to a concentration of the trivalent chromium compound on a surface of the film is 0.01 or more and 4.0 or less.

According to the lead wire, the film including the trivalent chromium compound leads to an improvement in corrosion resistance. In addition, when the lead wire includes a thermal fusion layer, the film including the first metal leads to an improvement in adhesiveness between the film and the thermal fusion layer.

Furthermore, the ratio of the concentration of the first metal to the concentration of the trivalent chromium compound on the surface of the film being 4.0 or less leads to an improvement in corrosion resistance. Therefore, the lead wire is a lead wire having a high degree of corrosion resistance and adhesiveness.

[2] Preferably, the ratio of the concentration of the first metal to the concentration of the trivalent chromium compound on the surface of the film is 0.1 or more and 4.0 or less. By defining the ratio within such a range, a lead wire having a high degree of corrosion resistance and adhesiveness is attained more reliably.

[3] A lead wire according to another aspect of the present disclosure is a lead wire including a lead conductor and a film covering at least a part of a surface of the lead conductor, wherein
the film includes a trivalent chromium compound and a hydroxide of an element constituting a first metal,
the trivalent chromium compound includes chromium hydroxide,
a ratio of a concentration of chromium hydroxide to a concentration of the trivalent chromium compound on a surface of the film is 0.3 or more and 0.9 or less, and
a ratio of a concentration of the hydroxide of the element constituting the first metal to the concentration of the trivalent chromium compound on the surface of the film is 0.01 or more and 1.0 or less.

According to the lead wire, the film including the trivalent chromium compound leads to an improvement in corrosion resistance. In addition, when the lead wire includes a thermal fusion layer, the film including the hydroxide of the element constituting the first metal and chromium hydroxide causes formation of a hydrogen bond, which leads to an improvement in adhesiveness between the film and the thermal fusion layer. Furthermore, when the lead wire includes a thermal fusion layer, the ratio of the concentration of chromium hydroxide to the concentration of the trivalent chromium compound on the surface of the film being 0.3 or more and 0.9 or less, and the ratio of the concentration of the hydroxide of the element constituting the first metal to the concentration of the trivalent chromium compound on the surface of the film being 0.01 or more and 1.0 or less lead to an improvement in adhesiveness between the film and the thermal fusion layer. Therefore, the lead wire is a lead wire having a high degree of corrosion resistance and adhesiveness.

[4] A lead wire according to still another aspect of the present disclosure is a lead wire including a lead conductor and a film covering at least a part of a surface of the lead conductor, wherein
the film includes a trivalent chromium compound, a first metal and a calcium compound, and
a ratio of a concentration of calcium to a concentration of the trivalent chromium compound on a surface of the film is 0.01 or more and 1.0 or less.

According to the lead wire, the film including the trivalent chromium compound leads to an improvement in corrosion resistance. In addition, when the lead wire includes a thermal fusion layer, the film including the first metal leads to an improvement in adhesiveness between the film and the thermal fusion layer. Furthermore, the film including the calcium compound leads to an improvement in stability with respect to a decomposition product of an electrolytic solution component in a power storage device and leads to an improvement in corrosion resistance. Moreover, when the lead wire includes a thermal fusion layer, the ratio of the concentration of calcium to the concentration of the trivalent chromium compound on the surface of the film being 0.01 or more and 1.0 or less leads to an improvement in adhesiveness between the film and the thermal fusion layer. Therefore, the lead wire is a lead wire having a high degree of corrosion resistance and adhesiveness.

[5] Preferably, the calcium compound includes at least one selected from the group consisting of calcium hydroxide, calcium oxide, calcium sulfate, and calcium carbonate. By defining the calcium compound as described above, a lead wire having a high degree of corrosion resistance and adhesiveness is attained more reliably.

[6] The first metal is a metal having the highest content rate in a first region surrounded by the surface of the film and an imaginary surface located parallel to the surface of the film at a distance of 500 nm from the surface of the film.

[7] Preferably, the first metal is at least one selected from the group consisting of nickel, aluminum and copper.

[8] Preferably, the film further includes metal chromium. By defining the film as described above, a lead wire having a high degree of corrosion resistance and adhesiveness is attained more reliably.

[9] Preferably, a content of chromium included in the film is 0.1 mg/m² or more and less than 20 mg/m². By defining the content of chromium within such a range, a lead wire having a high degree of corrosion resistance and adhesiveness is attained more reliably.

[10] Preferably, the lead wire further includes a thermal fusion layer covering at least a part of the film.

[11] Preferably, the thermal fusion layer is made of a maleic anhydride-modified polyolefin-based resin. By defining the thermal fusion layer as described above, a lead wire having a high degree of corrosion resistance and adhesiveness is attained more reliably.

[12] Preferably, a thickness of the film is 1 nm or more and 50 nm or less. By defining the thickness of the film within such a range, a lead wire having a high degree of corrosion resistance and adhesiveness is attained more reliably.

[13] Preferably, the film further includes a fluorine compound, and a concentration of fluorine on the surface of the film is 0.1 atomic % or more and 5.0 atomic % or less. By defining the film as described above, a lead wire having a high degree of corrosion resistance and adhesiveness is attained more reliably.

[14] Preferably, the film does not include a hexavalent chromium compound. This is because the hexavalent chromium compound is an environmentally hazardous substance.

[15] The lead conductor may be nickel, a nickel-plated metal, or a nickel-phosphorus alloy-plated metal.

[16] The lead conductor may be aluminum or an aluminum alloy.

[17] The lead conductor may be copper or a copper alloy.

[18] A power storage device of the present disclosure includes the lead wire as recited in any one of [1] to [17]. The power storage device configured as described above has excellent and a high degree of corrosion resistance and adhesiveness.

### DETAILS OF EMBODIMENTS

Hereinafter, an embodiment of the present disclosure (hereinafter, denoted as “the present embodiment”) will be described. However, the present embodiment is not limited to the description. In the present specification, when an element symbol or an element name is indicated, the element symbol or the element name may refer to a substance made only of the element, or may refer to a constituent element in a compound.

### First Embodiment

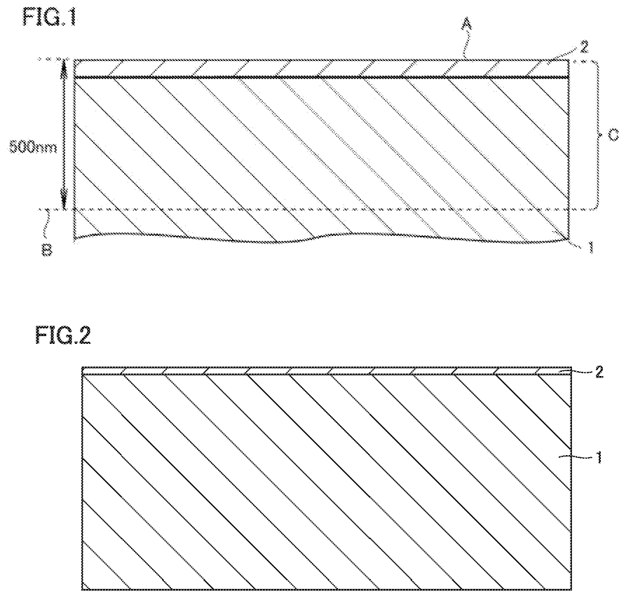

A lead wire according to the present embodiment will be described with reference to FIGS. 1 and 2. The lead wire according to the present embodiment includes a lead conductor 1, and a film 2 covering at least a part of a surface of lead conductor 1. Film 2 includes a trivalent chromium compound and a first metal, and a ratio of a concentration of the first metal to a concentration of the trivalent chromium compound on a surface A of the film is 0.01 or more and 4.0 or less.

### <Lead Conductor>

The lead conductor is a conductive member and is, for example, a member that electrically connects an electrode housed in a container of a power storage device to an external member. The lead conductor is made of a highly conductive material and includes a first metal. The first metal is an arbitrary metal included in the material constituting the lead conductor, and is preferably at least one selected from the group consisting of nickel (Ni), aluminum (Al) and copper (Cu).

Examples of the highly conductive material constituting the lead conductor include the first metal, a plated metal, an alloy and the like. Examples of the plated metal include a nickel-plated metal, a nickel-phosphorus alloy-plated metal and the like. Examples of the alloy include an aluminum alloy, a copper alloy and the like.

In addition, referring to FIG. 1, the first metal is a metal having the highest content rate in a first region C surrounded by surface A of the film and an imaginary surface B located parallel to surface A of the film at a distance of 500 nm from surface A of the film.

The first metal can be identified using the following method. Specifically, a cross section of the film obtained using a focused ion beam apparatus (FIB apparatus), a cross section polisher apparatus (CP apparatus) or the like is observed at a magnification of 20000 using a scanning transmission electron microscope (SEM).

As to the above-described observation field, elemental quantitative analysis is performed on the above-described first region by using an energy dispersive X-ray spectrometry (hereinafter, may be referred to as “EDX”) attached to the SEM, to thereby identify a metal element occupying the largest area as the first metal.

Although the shape of the lead conductor is not particularly limited, a flat plate shape having a thickness of 50 μm to 1000 μm, a width of 1 mm to 200 mm, and a length of 5 mm to 200 mm can be preferably used.

### <Film>

The film covers at least a part of the surface of the lead conductor. Although the film is preferably provided on the entire surface of the lead conductor, the film may cover at least a part of the surface of the lead conductor. In the present embodiment, “surface of the film” refers to a surface opposite to a side that is in contact with the lead conductor, and this also applies to below-described second and third embodiments.

### (Chromium)

The film includes the trivalent chromium (Cr) compound. The film including the trivalent chromium compound leads to an improvement in corrosion resistance of the film. The trivalent chromium compound is a compound including trivalent chromium, and examples of the trivalent chromium compound include chromium hydroxide, chromium chloride, chromium sulfate, chromium acetate, chromium nitrate and the like.

The film may further include metal chromium. The film including metal chromium leads to an improvement in adhesiveness between the lead conductor and the film and a high degree of corrosion resistance can be attained.

A content of chromium included in the film is, for example, 0.1 mg/m² or more and less than 20 mg/m². Herein, chromium included in the film indicates a total amount of the trivalent chromium compound and metal chromium in terms of a chromium equivalent amount. When the content of chromium included in the film is less than 0.1 mg/m², the film is not formed uniformly, and thus, the corrosion resistance tends to decrease. When the content of chromium included in the film is 20 mg/m² or more, a crack is easily formed in the film, and thus, the corrosion resistance tends to decrease. The concentration of chromium included in the film is preferably 1 mg/m² or more and less than 15 mg/m², and more preferably 3 mg/m² or more and less than 10 mg/m².

The content of chromium included in the film can be measured using inductively coupled plasma-mass spectrometry (hereinafter, sometimes referred to as “ICP-MS”). The content of chromium included in the film can be obtained, for example, by cutting the lead conductor covered with the film, immersing the lead conductor in a hydrochloric acid solution to dissolve the lead conductor, and measuring a concentration of chromium in the obtained solution by using an inductively coupled plasma-mass spectrometer (ICP-MS7700x manufactured by Agilent Technologies).

In addition, the presence or absence of metal chromium in the film can be determined by measuring an X-ray absorption spectrum using a fluorescence yield method. As a facility for measuring the X-ray absorption spectrum, a synchrotron radiation facility (SAGA-LS BL16) can, for example, be used. In this facility, an outermost surface of the film is irradiated with an X ray, to thereby obtain an X-ray absorption spectrum. As to the obtained X-ray absorption spectrum, an X-ray energy value on a horizontal axis is calibrated using metal chromium, and then, standardization and background processing are performed using software (e.g., REX2000 manufactured by Rigaku Corporation). Then, a ratio of X-ray absorption at 5990 eV to X-ray absorption at 6007 eV is obtained. When the ratio is 0.1 or more, it can be considered that metal chromium is included in the film.

### (First Metal)

The film includes the first metal. When the lead wire according to the present embodiment includes a thermal fusion layer described below, the film including the first metal leads to an improvement in adhesiveness between the film and the thermal fusion layer.

### (Ratio of Concentration of First Metal to Concentration of Trivalent Chromium Compound)

A ratio of a concentration of the first metal to a concentration of the trivalent chromium compound on the surface of the film is 0.01 or more and 4.0 or less. When the ratio of the concentration of the first metal to the concentration of the trivalent chromium compound on the surface of the film exceeds 4.0, the film is formed non-uniformly, and thus, the corrosion resistance tends to decrease. The ratio of the concentration of the first metal to the concentration of the trivalent chromium compound on the surface of the film is preferably 3.0 or less, more preferably 2.0 or less, and further preferably 1.5 or less. In addition, the ratio of the concentration of the first metal to the concentration of the trivalent chromium compound on the surface of the film may be, for example, 0.1 or more, may be 0.3 or more, and may be 0.5 or more.

The concentration of the trivalent chromium compound and the concentration of the first metal on the surface of the film can be measured using an X-ray photoelectron spectroscopy (hereinafter, sometimes referred to as “XPS”). The XPS measurement conditions are, for example, as described below. In addition, the ratio of the concentration of the first metal to the concentration of the trivalent chromium compound on the film can be calculated by performing curve fitting of a spectrum obtained under the below-described measurement conditions and obtaining a ratio of a peak area.

### [XPS Measurement Conditions]

X-Ray Source: Al-Kα
Output of X-ray source: 15 kV
Photoelectron extraction angle: 45°
Analysis area: 100 μmΦ

The surface of the film may have a defect in some cases. The defect occurs, for example, when the film is formed on the surface of the lead conductor. When the lead wire includes the film according to the present embodiment even if the surface of the film has a defect, sufficient corrosion resistance and adhesiveness are attained.

### (Fluorine Compound)

The film may include a fluorine (F) compound. The film including the fluorine compound leads to an improvement in stability with respect to a decomposition product of an electrolytic solution component in a power storage device and a high degree of corrosion resistance can be attained.

A fluorine concentration of the fluorine compound on the surface of the film is preferably 0.1 atomic % or more and 5.0 atomic % or less, and more preferably 0.3 atomic % or more and 4.5 atomic % or less. When the fluorine concentration of the fluorine compound on the surface of the film is less than 0.1 atomic %, the corrosion resistance tends to decrease. When the fluorine concentration of the fluorine compound on the surface of the film exceeds 5.0 atomic %, the adhesiveness between the lead conductor and the film tends to decrease.

The fluorine concentration on the surface of the film can be measured using the XPS. The XPS measurement conditions are, for example, as described below.

### [XPS Measurement Conditions]

X-ray source: Al-Kα
Output of X-ray source: 15 kV
Photoelectron extraction angle: 45°
Analysis area: 100 μmΦ

### (Thickness of Film)

A thickness of the film is preferably 1 nm or more and 50 nm or less, and more preferably 3 nm or more and 20 nm or less. When the thickness of the film is less than 1 nm, the film is not formed uniformly, and thus, the corrosion resistance tends to decrease. When the thickness of the film exceeds 50 nm, a crack is easily formed in the film and a film density tends to become smaller, and thus, the corrosion resistance tends to decrease.

The thickness of the film can be measured in SiO₂ terms. The thickness of the film is defined, for example, by a sputter depth in SiO₂ terms at which a composition ratio of the chromium element becomes a half of a maximum value as a result of depth direction analysis by the XPS under the following conditions.

### [XPS Analysis Conditions]

X-ray source: Al-Kα
Output of X-ray source: 15 kV
Photoelectron extraction angle: 45° Analysis area: 100 μmΦ

### (Others)

The other components included in the film include carbon, nitrogen, oxygen, sodium, phosphorus, sulfur, chlorine, potassium and the like.

Preferably, the film does not include a hexavalent chromium compound from the perspective of environmental protection in recent years. Examples of the hexavalent chromium compound include dichromate, chromate and the like. The film not including the hexavalent chromium compound preferably means that the film does not include the hexavalent chromium compound at all. However, the film may include the hexavalent chromium compound if hexavalent chromium in the hexavalent chromium compound is equal to or lower than a detection limit. Not including the hexavalent chromium compound can be checked in accordance with JIS H 8625.

### <Thermal Fusion Layer>

The lead wire according to the present embodiment may further include a thermal fusion layer. The thermal fusion layer may cover at least a part of the film and does not necessarily need to be provided on the entire film.

An arbitrary resin that melts by heat (250° C. to 300° C.) during thermal fusion can be used for the thermal fusion layer, and examples of the resin include a polyolefin-based resin, an acid-modified styrene-based elastomer and the like. Examples of the polyolefin-based resin include polyethylene, polypropylene, ionomer resin, acid-modified polyolefin and the like. Acid-modified polyolefin modified by maleic acid, acrylic acid, methacrylic acid, maleic anhydride or the like to have an adhesive functional group is preferable, and a maleic anhydride-modified polyolefin resin having excellent adhesiveness to metal and adhesiveness is more preferable.

In addition to these resins, various additives such as a flame retardant, an ultraviolet absorber, a light stabilizer, a heat stabilizer, a lubricant, and a colorant can be used for the thermal fusion layer. These resin materials and additives are mixed using a known mixing apparatus such as an open roll, a pressure kneader, a single shaft mixer, or a double shaft mixer, and then, a film-like thermal fusion layer is produced by extrusion molding or the like. Although a thickness of the thermal fusion layer depends on a thickness of lead conductor 1, the thickness of the thermal fusion layer is preferably 30 μm to 200 μm.

The thermal fusion layer can also be crosslinked by irradiation with an accelerated electron beam or ionized radiation such as a γ-ray. Crosslinking can lead to a higher degree of heat resistance and can prevent a decrease in adhesion force when the temperature rises during use. The entire thermal fusion layer may be crosslinked, or the thermal fusion layer may have a multi-layer structure formed by stacking a non-crosslinked layer and a crosslinked layer.

### <Peel Strength>

In the lead wire according to the present embodiment, the adhesion force between the lead conductor and the thermal fusion layer can be evaluated by measuring a peel strength using the following method. The peel strength can be obtained, for example, by cutting one of the lead conductor and the thermal fusion layer of the lead wire and bending the cut portion at 180°, placing the cut portion in a tensile testing machine (EX-SX manufactured by Shimadzu Corporation), and then, pulling the placed cut portion at a tensile speed of 50 mm/min. The larger a value of the peel strength is, the better the adhesion force between the lead conductor and the thermal fusion layer is and the better the corrosion resistance is.

### Second Embodiment

Referring to FIGS. 1 and 2, a lead wire according to the present embodiment includes lead conductor 1 and film 2 covering at least a part of a surface of lead conductor 1. Film 2 includes a trivalent chromium compound and a hydroxide of an element constituting a first metal, and the trivalent chromium compound includes chromium hydroxide. A ratio of a concentration of chromium hydroxide to a concentration of the trivalent chromium compound on surface A of the film is 0.3 or more and 0.9 or less, and a ratio of a concentration of the hydroxide of the element constituting the first metal to the concentration of the trivalent chromium compound on surface A of the film is 0.01 or more and 1.0 or less. Although the lead wire according to the present embodiment will be described below, the description overlapping with the first embodiment will not be repeated.

### (Hydroxide)

The film includes the hydroxide, and specifically the hydroxide of the element constituting the first metal, and chromium hydroxide. When the lead wire according to the present embodiment includes a thermal fusion layer, the film including the hydroxide of the element constituting the first metal and chromium hydroxide causes formation of a hydrogen bond between a hydroxyl group formed on a surface of the metal including the first metal and a hydroxyl group of the hydroxide, which leads to an improvement in adhesiveness between the film and the thermal fusion layer. Examples of the hydroxide of the element constituting the first metal include nickel(II) hydroxide, aluminum hydroxide, copper(II) hydroxide and the like.

### (Ratio of Concentration of Chromium Hydroxide to Concentration of Trivalent Chromium Compound)

A ratio of a concentration of chromium hydroxide to a concentration of the trivalent chromium compound on the surface of the film is 0.3 or more and 0.9 or less. When the lead wire according to the present embodiment includes the thermal fusion layer, the ratio of the concentration of chromium hydroxide to the concentration of the trivalent chromium compound on the surface of the film being 0.3 or more and 0.9 or less leads to an improvement in adhesiveness between the film and the thermal fusion layer. The ratio of the concentration of chromium hydroxide to the concentration of the trivalent chromium compound on the surface of the film is preferably 0.35 or more and 0.8 or less, and more preferably 0.4 or more and 0.7 or less.

### (Ratio of Concentration of Hydroxide of Element Constituting First Metal to Concentration of Trivalent Chromium Compound)

A ratio of a concentration of the hydroxide of the element constituting the first metal to the concentration of the trivalent chromium compound on the surface of the film is 0.01 or more and 1.0 or less. When the lead wire according to the present embodiment includes the thermal fusion layer, the ratio of the concentration of the hydroxide of the element constituting the first metal to the concentration of the trivalent chromium compound on the surface of the film being 0.01 or more and 1.0 or less leads to an improvement in adhesiveness between the film and the thermal fusion layer. The ratio of the concentration of the hydroxide of the first metal to the concentration of the trivalent chromium compound on the surface of the film is preferably 0.05 or more and 0.8 or less, and more preferably 0.1 or more and 0.6 or less.

The concentrations of the trivalent chromium compound, chromium hydroxide and the hydroxide of the element constituting the first metal on the surface of the film can be measured using the XPS. The XPS measurement conditions are, for example, as described below. In addition, the ratio of the concentration of chromium hydroxide to the concentration of the trivalent chromium compound on the surface of the film and the ratio of the concentration of the hydroxide of the element constituting the first metal to the concentration of the trivalent chromium compound on the surface of the film can be calculated by performing curve fitting of a spectrum obtained under the below-described measurement conditions and obtaining a ratio of a peak area.

### [XPS Measurement Conditions]

X-ray source: Al-Kα
Output of X-ray source: 15 kV
Photoelectron extraction angle: 45° Analysis area: 100 μmΦ

### Third Embodiment

Referring to FIGS. 1 and 2, a lead wire according to the present embodiment includes lead conductor 1 and film 2 covering at least a part of a surface of lead conductor 1. Film 2 includes a trivalent chromium compound, a first metal and a calcium compound. A ratio of a concentration of calcium to a concentration of the trivalent chromium compound on surface A of the film is 0.01 or more and 1.0 or less. Although the lead wire according to the present embodiment will be described below, the description overlapping with the first and second embodiments will not be repeated.

### (Calcium Compound)

The film includes a calcium (Ca) compound. The film including the calcium compound leads to an improvement in stability with respect to a decomposition product of an electrolytic solution component in a power storage device and excellent corrosion resistance can be attained. Although not particularly limited, examples of the calcium compound include calcium hydroxide, calcium oxide, calcium sulfate, calcium carbonate and the like.

A ratio of a concentration of calcium to a concentration of the trivalent chromium compound on the surface of the film is 0.01 or more and 1.0 or less. When the lead wire according to the present embodiment includes a thermal fusion layer, the ratio of the concentration of calcium to the concentration of the trivalent chromium compound on the surface of the film being 0.01 or more and 1.0 or less leads to an improvement in adhesiveness between the film and the thermal fusion layer. The ratio of the concentration of calcium to the concentration of the trivalent chromium compound on the surface of the film is preferably 0.03 or more and 0.7 or less, and more preferably 0.05 or more and 0.4 or less.

The concentration of the trivalent chromium compound and the concentration of calcium on the surface of the film can be measured using the XPS. The XPS measurement conditions are, for example, as described below. In addition, the ratio of the concentration of calcium to the concentration of the trivalent chromium compound on the surface of the film can be calculated by performing curve fitting of a spectrum obtained under the below-described measurement conditions and obtaining a ratio of a peak area.

### [XPS Measurement Conditions]

X-ray source: Al-Kα
Output of X-ray source: 15 kV
Photoelectron extraction angle: 45°
Analysis area: 100 μmΦ

### <<Applications>>

The lead wire according to each of the first to third embodiments is suitably used in a power storage device. Examples of the power storage device include a non-aqueous electrolyte battery using a non-aqueous electrolytic solution, an electric double layer capacitor, a water-based electrolyte battery including water as a main solvent of an electrolytic solution, and the like.

### EXAMPLES

Although the present disclosure will be described in detail below with reference to the examples, the present disclosure is not limited thereto.

### <<Production of Lead Wire>>

### <Sample 1>

### (Production of Lead Conductor)

An oxygen-free copper plate (C1020) having a length of 100 mm, a width of 45 mm and a thickness of 0.2 mm was used as a base member of a lead conductor. As pretreatment, the base member was immersed in a sodium hydroxide aqueous solution (40 g/L) at 25° C., and cathode electrolytic degreasing was performed at a current density of 1.0 A/dm². The base member subjected to degreasing was washed with running water.

Next, the washed base member was immersed for 30 seconds in a sulfuric acid aqueous solution (10 mass %) at 25° C., and acid activation was performed. The base member subjected to acid activation was washed with running water.

Next, a nickel amidosulfate tetrahydrate (350 g/L), a nickel chloride hexahydrate (30 g/L) and boric acid (30 g/L) were mixed to obtain a nickel plating solution. The acid-activated base member was immersed in the nickel plating solution at 50° C., and plating was performed at a current density of 5.0 A/dm² for 120 seconds. The base member subjected to plating was washed with running water. A lead conductor made of nickel-plated copper (metal plated with nickel) was thus obtained.

### (Formation of Film)

A chromium chloride hexahydrate (5.0 g/L) and potassium formate (170 g/L) were mixed with pure water to obtain a surface treatment solution. The lead conductor was immersed in the surface treatment solution at 45° C., and cathode electrolysis was performed at a current density of 10 A/dm² for 30 seconds. The lead conductor subjected to cathode electrolysis was washed with running water. A lead conductor including a film described in Table 1 was thus obtained.

### (Formation of Thermal Fusion Layer)

A maleic anhydride-modified polypropylene film having a thickness of 50 μm was applied to each of both surfaces of the lead conductor including the film, and pressing was performed at 260° C. for 30 seconds to bond the maleic anhydride-modified polypropylene film to each of both surfaces of the lead conductor. A lead wire of Sample 1 was thus produced.

### <Samples 2 to 5 and A to C>

As to each of Samples 2 to 5 and A to C, a lead conductor similar to that of Sample 1 was used. As to Sample 2, a lead conductor including a film was obtained using a method similar to that of Sample 1, except that the time of cathode electrolysis was 40 seconds. As to Sample 3, a lead conductor including a film was obtained using a method similar to that of Sample 1, except that the time of cathode electrolysis was 5 seconds. As to Sample 4, a lead conductor including a film was obtained using a method similar to that of Sample 1, except that the concentration of the chromium chloride hexahydrate was 10 g/L. As to Sample 5, a lead conductor including a film was obtained using a method similar to that of Sample 1, except that the time of cathode electrolysis was 60 seconds and the concentration of the chromium chloride hexahydrate was 10 g/L. As to Sample A, a lead conductor including a film was obtained using a method similar to that of Sample 1, except that the current density was 1 A/dm². As to Sample B, a lead conductor including a film was obtained using a method similar to that of Sample 1, except that the concentration of the chromium chloride hexahydrate was 1.0 g/L. As to Sample C, a lead conductor including a film was obtained using a method similar to that of Sample 1, except that the time of cathode electrolysis was 90 seconds and the concentration of the chromium chloride hexahydrate was 10 g/L. In addition, a thermal fusion layer was formed using a method similar to that of Sample 1. A lead wire of each sample was thus produced.

### <Sample 6>

### (Production of Lead Conductor)

An aluminum plate (A1050) having a length of 100 mm, a width of 45 mm and a thickness of 0.2 mm was used as a base member of a lead conductor. As pretreatment, the base member was immersed in a sodium hydroxide aqueous solution (40 g/L) at 25° C., and cathode electrolytic degreasing was performed at a current density of 1.0 A/dm². The base member subjected to degreasing was washed with running water. A lead conductor was thus obtained.

### (Formation of Film)

A chromium chloride hexahydrate (5.0 g/L) and potassium formate (170 g/L) were mixed with pure water to obtain a surface treatment solution. The lead conductor was immersed in the surface treatment solution at 45° C., and cathode electrolysis was performed at a current density of 10 A/dm² for 10 seconds. The lead conductor subjected to cathode electrolysis was washed with running water. A lead conductor including a film described in Table 1 was thus obtained.

### (Formation of Thermal Fusion Layer)

A thermal fusion layer was formed using a method similar to that of Sample 1. A lead wire of Sample 6 was thus produced.

### <Sample 7>

As to Sample 7, a lead wire was produced using a method similar to that of Sample 6, except that potassium fluoride (5.0 g/L) was further mixed with the above-described surface treatment solution of Sample 6.

### <Sample 8>

An oxygen-free copper plate (C1020) having a length of 100 mm, a width of 45 mm and a thickness of 0.2 mm was used as a base member of a lead conductor. As pretreatment, the base member was immersed in a sodium hydroxide aqueous solution (40 g/L) at 25° C., and cathode electrolytic degreasing was performed at a current density of 1.0 A/dm². The base member subjected to degreasing was washed with running water. Next, the washed base member was immersed for 30 seconds in a sulfuric acid aqueous solution (10 mass %) at 25° C., and acid activation was performed.

The base member subjected to acid activation was washed with running water. A lead conductor was thus obtained. Formation of a film and formation of a thermal fusion layer were performed using a method similar to that of Sample 1.

### <Sample 9>

### (Production of Lead Conductor)

A lead conductor made of nickel-plated copper (metal plated with nickel) was produced using a method similar to that of Sample 1.

### (Formation of Film)

A chromium chloride hexahydrate (5.0 g/L) and potassium formate (170 g/L) were mixed with pure water to obtain a surface treatment solution. The lead conductor was immersed in the surface treatment solution at 45° C., and cathode electrolysis was performed at a current density of 10 A/dm² for 30 seconds. The lead conductor subjected to cathode electrolysis was washed with running water and dried for 180 seconds in a constant temperature bath at 100° C. A lead conductor including a film described in Table 2 was thus obtained.

### (Formation of Thermal Fusion Layer)

A thermal fusion layer was formed using a method similar to that of Sample 1. A lead wire of Sample 9 was thus produced.

### <Samples 10 to 13 and D to E>

As to each of Samples 10 to 13 and D to E, a lead conductor similar to that of Sample 9 was used. As to Sample 10, a lead conductor including a film was obtained using a method similar to that of Sample 9, except that the time of cathode electrolysis was 5 seconds. As to Sample 11, a lead conductor including a film was obtained using a method similar to that of Sample 9, except that the concentration of the chromium chloride hexahydrate was 10 g/L. As to Sample 12, a lead conductor including a film was obtained using a method similar to that of Sample 9, except that the time of drying after cathode electrolysis was 30 seconds. As to Sample 13, a lead conductor including a film was obtained using a method similar to that of Sample 9, except that the time of drying after cathode electrolysis was 3600 seconds. As to Sample D, a lead conductor including a film was obtained using a method similar to that of Sample 9, except that drying was performed for 3600 seconds in a constant temperature bath at 250° C. after cathode electrolysis. As to Sample E, a lead conductor including a film was obtained using a method similar to that of Sample 9, except that the concentration of the chromium chloride hexahydrate was 1.0 g/L. In addition, a thermal fusion layer was formed using a method similar to that of Sample 1. A lead wire of each sample was thus produced.

### <Sample 14>

### (Production of Lead Conductor)

A lead conductor made of nickel-plated copper (metal plated with nickel) was produced using a method similar to that of Sample 1.

### (Formation of Film)

A chromium chloride hexahydrate (5.0 g/L), potassium formate (170 g/L) and calcium chloride (0.5 g/L) were mixed with pure water to obtain a surface treatment solution. The lead conductor was immersed in the surface treatment solution at 45° C., and cathode electrolysis was performed at a current density of 10 A/dm² for 30 seconds. The lead conductor subjected to cathode electrolysis was washed with running water and dried for 180 seconds in a constant temperature bath at 100° C. A lead conductor including a film described in Table 3 was thus obtained.

### (Formation of Thermal Fusion Layer)

A thermal fusion layer was formed using a method similar to that of Sample 1. A lead wire of Sample 14 was thus produced.

### <Samples 15 and F>

As to each of Samples 15 and F, a lead conductor similar to that of Sample 14 was used. As to Sample 15, a lead conductor including a film was obtained using a method similar to that of Sample 14, except that the concentration of calcium chloride was 3.0 g/L. As to Sample F, a lead conductor including a film was obtained using a method similar to that of Sample 14, except that the concentration of calcium chloride was 5.0 g/L. In addition, a thermal fusion layer was formed using a method similar to that of Sample 1. A lead wire of each sample was thus produced.

The lead wires of Samples 1 to 15 correspond to examples. The lead wires of Samples A to F correspond to comparative examples.

TABLE 1

| | Film | | | | | Peel strength | |
|---|---|---|---|---|---|---|---|
| | | Cr | Ratio of | | Thick- | Initial | Four- |
| Sam- | First | content | concentration | Metal | ness | (N/ | week |
| ple | metal | (mg/m²) | of first metal | Cr | (nm) | cm²) | (N/cm²) |
| 1 | Ni | 3 | 0.6 | present | 4 | 18 | 12 |
| 2 | Ni | 4 | 0.3 | present | 6 | 18 | 12 |
| 3 | Ni | 1.5 | 3.0 | present | 2 | 18 | 10 |
| 4 | Ni | 12 | 0.2 | present | 18 | 18 | 13 |
| 5 | Ni | 15 | 0.08 | present | 20 | 17 | 10 |
| 6 | Al | 10 | 1.0 | present | 13 | 18 | 11 |
| 7 | Al | 15 | 1.0 | present | 22 | 18 | 13 |
| 8 | Cu | 3 | 0.6 | present | 4 | 18 | 12 |
| A | Ni | 3 | 5 | absent | 6 | 18 | 0 |
| B | Ni | 1 | 10 | present | 2 | 18 | 0 |
| C | Ni | 18 | 0 | present | 22 | 16 | 5 |

TABLE 2

| | Film | | | | | | | |
|---|---|---|---|---|---|---|---|---|
| | | | | Ratio of | | | | |
| | | | | concentration | | | | |
| | | | Ratio of | of hydroxide | | | | |
| | | Cr | concentration | of element | | | Peel strength | |
| | First | content | of | constituting | Metal | Thickness | Initial | Four-week |
| Sample | metal | (mg/m²) | Cr hydroxide | first metal | Cr | (nm) | (N/cm²) | (N/cm²) |
| 9 | Ni | 3 | 0.40 | 0.4 | present | 4 | 18 | 14 |
| 10 | Ni | 1.5 | 0.40 | 0.8 | present | 2 | 18 | 12 |
| 11 | Ni | 12 | 0.40 | 0.1 | present | 18 | 18 | 15 |
| 12 | Ni | 3 | 0.80 | 0.4 | present | 4 | 18 | 12 |
| 13 | Ni | 3 | 0.32 | 0.4 | present | 4 | 18 | 14 |
| D | Ni | 3 | 0.20 | 0.4 | present | 4 | 18 | 0 |
| E | Ni | 3 | 0.40 | 1.2 | absent | 6 | 18 | 5 |

TABLE 3

| | Film | | | | | Peel strength | |
|---|---|---|---|---|---|---|---|
| | | Cr | Ratio of | | Thick- | Initial | Four- |
| Sam- | First | content | concentration | Metal | ness | (N/ | week |
| ple | metal | (mg/m²) | of Ca | Cr | (nm) | cm²) | (N/cm²) |
| 14 | Ni | 3 | 0.2 | absent | 6 | 18 | 14 |
| 15 | Ni | 3 | 0.8 | absent | 6 | 15 | 12 |
| E | Ni | 3 | 0 | absent | 6 | 18 | 0 |
| F | Ni | 1 | 1.2 | absent | 2 | 8 | 0 |

### <<Observation of Samples>>

### <First Metal>

As to each sample, a cross section of the film obtained using a cross section polisher apparatus (CP apparatus) was observed at a magnification of 20000 using an SEM, and elemental mapping was performed on a plurality of first regions using an EDX attached to the SEM. In the above-described elemental mapping, an element having the highest content rate was defined as the first metal. The result is shown in the “First metal” section in each of Tables 1 to 3. In the tables, Ni represents “nickel”, Al represents “aluminum”, and Cu represents “copper”.

### <Calculation of Chromium Content>

A portion of the produced lead wire of each sample to which the thermal fusion layer was not bonded was cut into a width of 10 mm and immersed for 60 minutes in dilute hydrochloric acid (3 mol/L) at 50° C. An amount of chromium in the obtained solution was measured using an inductively coupled plasma mass spectrometer (ICP-MS7700x manufactured by Agilent Technologies), and a content (mg/m²) of chromium included in the film was calculated from the obtained result. The result is shown in the “Cr content (mg/m²)” section in each of Tables 1 to 3.

### <Metal Chromium>

In a synchrotron radiation facility (SAGA-LS BL16), an outermost surface of the film of each sample was irradiated with an X ray, to thereby obtain an X-ray absorption spectrum. As to the obtained X-ray absorption spectrum, an X-ray energy value on a horizontal axis was calibrated using metal chromium, and then, standardization and background processing were performed using software (REX2000 manufactured by Rigaku Corporation). Then, a ratio of X-ray absorption at 5990 eV to X-ray absorption at 6007 eV was obtained, and the presence or absence of metal chromium in the film of each sample was checked. The result is shown in the “Metal Cr” section in each of Tables 1 to 3. When the ratio was 0.1 or more, “present” was written. When the ratio was less than 0.1, “absent” was written.

### <Thickness of Film>

Using an X-ray electron spectrometer (QuanteraSXM manufactured by ULVAC-PHI, INCORPORATED), depth direction analysis of the film of each sample was performed under the following conditions and a depth of the chromium element belonging to a peak of 573 eV to 578 eV was calculated in SiO₂ terms. In addition, an etching rate of SiO₂ measured using the X-ray electron spectrometer was 1.0 nm/min. The result is shown in the “Thickness (nm)” section in each of Tables 1 to 3.

### [XPS Measurement Conditions]

X-ray source: Al-Kα
Output of X-ray source: 15 kV
Photoelectron extraction angle: 45°
Analysis area: 100 μmΦ

### <Ratio of Concentration of First Metal>

Using the X-ray electron spectrometer (QuanteraSXM manufactured by ULVAC-PHI, INCORPORATED), the concentrations of the trivalent chromium compound and the first metal on the surface of the film of each of Samples 1 to 8 and A to C were measured under the same conditions as [XPS Measurement Conditions] in <Thickness of Film> described above, to thereby calculate a ratio of the concentration of the first metal to the concentration of the trivalent chromium compound on the surface of the film. The result is shown in the “Ratio of concentration of first metal” section in Table 1. The fluorine concentration of the film of Sample 7 was measured under the same conditions. Then, the fluorine concentration was 4.0 atomic %.

### <Ratio of Concentration of Chromium Hydroxide and Ratio of Concentration of Hydroxide of Element Constituting First Metal>

Using the X-ray electron spectrometer (QuanteraSXM manufactured by ULVAC-PHI, INCORPORATED), the concentrations of the trivalent chromium compound, chromium hydroxide, and the hydroxide of the element constituting the first metal on the surface of the film of each of Samples 9 to 13 and D to E were measured under the same conditions as [XPS Measurement Conditions] in <Thickness of Film> described above, to thereby calculate a ratio of the concentration of chromium hydroxide to the concentration of the trivalent chromium compound on the surface of the film and a ratio of the concentration of the hydroxide of the element constituting the first metal to the concentration of the trivalent chromium compound on the surface of the film. The result is shown in the “Ratio of concentration of Cr hydroxide” and “Ratio of concentration of hydroxide of element constituting first metal” sections in Table 2.

### <Ratio of Concentration of Calcium>

Using the X-ray electron spectrometer (QuanteraSXM manufactured by ULVAC-PHI, INCORPORATED), the concentrations of the trivalent chromium compound and calcium on the surface of the film of each of Samples 14 to 15 and E to F were measured under the same conditions as [XPS Measurement Conditions] in <Thickness of Film> described above, to thereby calculate a ratio of the concentration of calcium to the concentration of the trivalent chromium compound on the surface of the film. The result is shown in the “Ratio of concentration of Ca” section in Table 3.

### <<Evaluation Test>>

### <Peel Test>

The peel strength of each of Samples 1 to 15 and Samples A to F was measured using the following method. In this test, “initial peel strength”, which is a peel strength after production, and “four-week peel strength”, which is a peel strength four weeks after production, were measured.

### (Initial Peel Strength)

The initial peel strength was measured by cutting one of the lead conductor and the thermal fusion layer of each of Samples 1 to 15 and A to F and bending the cut portion at 180°, placing the cut portion in a tensile testing machine (EX-SX manufactured by Shimadzu Corporation), and then, pulling the placed cut portion at a tensile speed of 50 mm/min. The result is shown in the “Peel strength Initial (N/cm²)” section in each of Tables 1 to 3. When the initial peel strength is 15 N/cm² or more, the lead wire can be evaluated as having a high degree of adhesiveness.

### (Four-Week Peel Strength)

Ethylene carbonate, diethyl carbonate and dimethyl carbonate were mixed at a volume ratio of 1:1:1, to thereby prepare a test solution having lithium hexafluorophosphate (LiPF6) dissolved therein at 1.0 mol/L. Each of Samples 1 to 11 and A to E was immersed in this test solution, and the test solution was adjusted such that a moisture rate thereof became 1000 ppm, and left for four weeks in a constant temperature bath at 80° C. Then, measurement was performed using the same method as that in “(Initial Peel Strength)” described above. The result is shown in the “Peel strength Four-week (N/cm²)” section in each of Tables 1 to 3. The above-described test solution is a test solution commonly used as an electrolytic solution for battery elements in a power storage device, and is produced to evaluate the corrosion resistance of the lead wire. When the four-week peel strength is 10 N/cm² or more, the lead wire can be evaluated as having a high degree of corrosion resistance.

### <Discussion>

Each of Samples 1 to 8 in which the ratio of the concentration of the first metal to the concentration of the trivalent chromium compound on the surface of the film is 0.01 or more and 4.0 or less exhibited the large values of both the initial peel strength and the four-week peel strength. This shows that the lead wire of each sample described above has a high degree of corrosion resistance and adhesiveness.

In contrast, each of Samples A to C in which the ratio of the concentration of the first metal to the concentration of the trivalent chromium compound on the surface of the film is not within the range of 0.01 to 4.0 had a high degree of adhesiveness but exhibited a decrease in corrosion resistance.

Each of Samples 9 to 13 in which the ratio of the concentration of chromium hydroxide to the concentration of the trivalent chromium compound on the surface of the film is 0.3 or more and 0.9 or less and the ratio of the concentration of the hydroxide of the element constituting the first metal to the concentration of the trivalent chromium compound on the surface of the film is 0.01 or more and 1.0 or less exhibited the large values of both the initial peel strength and the four-week peel strength. This shows that the lead wire of each sample described above has a high degree of corrosion resistance and adhesiveness.

In contrast, each of Sample D in which the ratio of the concentration of chromium hydroxide to the concentration of the trivalent chromium compound on the surface of the film is 0.2 and Sample E in which the ratio of the concentration of the hydroxide of the element constituting the first metal to the concentration of the trivalent chromium compound on the surface of the film is 1.2 had a high degree of adhesiveness but exhibited a decrease in corrosion resistance.

Each of Samples 14 to 15 in which the ratio of the concentration of calcium to the concentration of the trivalent chromium compound on the surface of the film is 0.01 or more and 1.0 or less exhibited the large values of both the initial peel strength and the four-week peel strength. This shows that the lead wire of each sample described above has a high degree of corrosion resistance and adhesiveness.

In contrast, Sample E that did not include calcium had a high degree of adhesiveness but exhibited a decrease in corrosion resistance. In addition, Sample F in which the ratio of the concentration of calcium to the concentration of the trivalent chromium compound on the surface of the film is 1.2 exhibited the small values of both the initial peel strength and the four-week peel strength.

Although the embodiments and examples of the present disclosure have been described above, it is originally intended to combine the features of the above-described embodiments and examples as appropriate.

It should be understood that the embodiments and examples disclosed herein are illustrative and non-restrictive in every respect. The scope of the present invention is defined by the terms of the claims, rather than the embodiments and examples above, and is intended to include any modifications within the scope and meaning equivalent to the terms of the claims.

### REFERENCE SIGNS LIST

1 lead conductor; 2 film; A surface of film; B imaginary surface; C first region.

1. A lead wire comprising a lead conductor and a film covering at least a part of a surface of the lead conductor, wherein
the film includes a trivalent chromium compound and a first metal, and
a ratio of a concentration of the first metal to a concentration of the trivalent chromium compound on a surface of the film is 0.01 or more and 4.0 or less.

2. The lead wire according to claim 1, wherein
the ratio of the concentration of the first metal to the concentration of the trivalent chromium compound on the surface of the film is 0.1 or more and 4.0 or less.

3. A lead wire comprising a lead conductor and a film covering at least a part of a surface of the lead conductor, wherein
the film includes a trivalent chromium compound and a hydroxide of an element constituting a first metal,
the trivalent chromium compound includes chromium hydroxide,
a ratio of a concentration of chromium hydroxide to a concentration of the trivalent chromium compound on a surface of the film is 0.3 or more and 0.9 or less, and
a ratio of a concentration of the hydroxide of the element constituting the first metal to the concentration of the trivalent chromium compound on the surface of the film is 0.01 or more and 1.0 or less.

4. A lead wire comprising a lead conductor and a film covering at least a part of a surface of the lead conductor, wherein
the film includes a trivalent chromium compound, a first metal and a calcium compound, and
a ratio of a concentration of calcium to a concentration of the trivalent chromium compound on a surface of the film is 0.01 or more and 1.0 or less.

5. The lead wire according to claim 4, wherein
the calcium compound includes at least one selected from the group consisting of calcium hydroxide, calcium oxide, calcium sulfate, and calcium carbonate.

6. The lead wire according to claim 1, wherein
the first metal is a metal having the highest content rate in a first region surrounded by the surface of the film and an imaginary surface located parallel to the surface of the film at a distance of 500 nm from the surface of the film.

7. The lead wire according to claim 1, wherein
the first metal is at least one selected from the group consisting of nickel, aluminum and copper.

8. The lead wire according to claim 1, wherein
the film further includes metal chromium.

9. The lead wire according to claim 1, wherein
a content of chromium included in the film is 0.1 mg/m² or more and less than 20 mg/m².

10. The lead wire according to claim 1, wherein
the lead wire further includes a thermal fusion layer covering at least a part of the film.

11. The lead wire according to claim 10, wherein
the thermal fusion layer is made of a maleic anhydride-modified polyolefin-based resin.

12. The lead wire according to claim 1, wherein
a thickness of the film is 1 nm or more and 50 nm or less.

13. The lead wire according to claim 1, wherein
the film further includes a fluorine compound, and
a concentration of fluorine on the surface of the film is 0.1 atomic % or more and 5.0 atomic % or less.

14. The lead wire according to claim 1, wherein
the film does not include a hexavalent chromium compound.

15. The lead wire according to claim 1, wherein
the lead conductor is nickel, a nickel-plated metal, or a nickel-phosphorus alloy-plated metal.

16. The lead wire according to claim 1, wherein
the lead conductor is aluminum or an aluminum alloy.

17. The lead wire according to claim 1, wherein
the lead conductor is copper or a copper alloy.

18. A power storage device comprising the lead wire as recited in claim 1.
